(19) United States
(12) Patent Application Publication
(10) Pub. No.: US 2022/0024022 A1
(43) Pub. Date: Jan. 27, 2022

(54) DISPOSABLE SANITARY BATHROOM DEVICE

(71) Applicant: Franklin Cosom, Bordentown, NJ (US)

(72) Inventor: Franklin Cosom, Bordentown, NJ (US)

(21) Appl. No.: 17/382,221

(22) Filed: Jul. 21, 2021

Related U.S. Application Data
(60) Provisional application No. 63/054,742, filed on Jul. 21, 2020.

(51) Int. Cl. B25G 1/10

(52) U.S. Cl. CPC B25G 1/102; A47K 13/10

(57) ABSTRACT

A disposable sanitary bathroom device configured to minimizes an individual's contact with bathroom bacteria via a flat end and a curved end manipulating critical touch points of a bathroom. A body of the device acts as a buffer between the bare hand of the user and the bathroom surface and can therefore be used to lift and lower a toilet seat as well as flush a toilet without having the user touch the with his/her hands. Parallel indented sides function as an ergonomic handle section to provide adequate grip and stability during use. The body is constructed from molded bathroom tissue. The flat end of the device is used to lift or lower a toilet seat. The curved end of the device is for flushing a toilet.

### CONTINUITY

This application is a non-provisional patent application of provisional application No. 63/054,742, filed on Jul. 21, 2020, and priority is claimed thereto.

### FIELD OF THE PRESENT INVENTION

The present invention relates to the field of personal, single-use sanitary products, and more specifically relates to a disposable sanitary bathroom device configured to enable a user to avoid personal physical contact with commonly touched surfaces in a bathroom to reduce personal contact with harmful bacteria and viruses.

### BACKGROUND OF THE PRESENT INVENTION

Bathrooms, by their nature, are not always the cleanest of spaces. Generally, a wide variety of harmful bacteria and viruses can be found on nearly every surface. In most scenarios, individuals tend to desire to touch the least amount of such germ-ridden surfaces as possible when going to the bathroom.

Unfortunately, some surfaces generally require contact for use. Surfaces such as the bathroom stall door, stall door locks, sink faucets, toilet seats, and toilet flush levers generally require at least minimal contact by the user to facilitate proper bathroom use. Some bathrooms are equipped with “touchless” bathroom hardware, such as automated sinks and toilet flush mechanisms. Even in these bathrooms, users are still required to touch the bathroom stall doors and latches. If there were a disposable device that could be used to further minimize any and all contact with bathroom surfaces, the exposure of the user to bacteria and viruses in the bathroom could be minimized.

Thus, there is a need for a device that minimizes an individual's contact with harmful bathroom bacteria. Such a device is preferably configured to eliminate the need to lift a toilet seat with his/her bare hands. Such a device may also be used to lower a toilet seat without directly using his/her hands to touch a toilet seat. Furthermore, the device would allow a person to flush a toilet without contacting the toilet with his/her bare hands. Still further, it would be desirable to have a device that is also disposable which may be used for other contact points in the bathroom, including the bathroom stall door, the stall door lock, and the bathroom sink faucet. There currently is not a device that addresses these hygienic needs. Therefore, there is a need in the bathroom hygiene industry for a disposable device that lifts and lowers a toilet seat and flushes a toilet and also minimizes contact with harmful bathroom bacteria.

Currently there are a number of solutions for avoiding hand contact with a toilet seat. Toilet seat handles are one. Conventional toilet seat handles are affixed to toilet seats by using adhesive to attach the handle to the bottom of the toilet seat, or they are integrated into the seats themselves. There are also toilet seats that are manufactured with a protruding handle. Both toilet seat handles are prone to carry germs after a person flushes a toilet. When toilets are flushed, they spew germs over a wide area, thus causing a fixed toilet seat handle to become contaminated with harmful bacteria. The flushing process then deems it necessary to clean a toilet seat handle after every flush of a toilet. The toilet seat handle is conventionally made from plastic, which is costly and is not designed to be disposable nor biodegradable. Similarly, conventional toilet seat handles are not designed to be multi-functional as they are designed to lift a toilet seat only. Toilet seat handles are not designed to solve the problem of touching a germ filled flush handle. They do not alleviate the problem of a user coming in contact with harmful bacteria found in bathrooms outside of the toilet seat region. As such, sole use of the toilet seat handle enhances a user's probability of coming in contact with harmful bathroom germs.

### SUMMARY OF THE PRESENT INVENTION

The present invention is a disposable sanitary bathroom device configured to alleviate additional restroom hygiene threats by offering a peace of mind for users. The present invention is configured to minimize the user's contact with bacteria by saving the user from having to actually touch a toilet seat, toilet flusher, bathroom stall door, and bathroom stall door lock/latch. As such, use of the present invention improves restroom hygiene, and ultimately minimizes bacteria present on bathroom surfaces. The present invention is affordably designed and is preferably disposable.

The present invention is also designed to avoid touching push-down bathroom sink faucets and/or opening bathroom doors equipped with lever-styled knobs where numerous germs are conventionally found. Conventional toilet seat handles cannot perform these function. It is envisioned that several instances of the present invention can be housed in a convenient accessible dispenser within the bathroom. Toilet seat handles are packaged to hold only a few plastic devices. It is envisioned that the device of the present invention can be packaged hundreds at a time.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 exhibits a diagram illustrating a side view of the disposable sanitary bathroom device.

FIG. 2 shows a top view of a preferred embodiment of the present invention.

FIG. 3 is a front flat end perspective in-use view of an embodiment of the disclosure.

FIG. 4 depicts a front curved end perspective in-use view of an embodiment of the disclosure.

FIG. 5A is a side view of the curved end of the present invention in use to manipulate a bathroom stall door latch.

FIG. 5B depicts a side view of the flat end of the present invention in use to manipulate a bathroom stall door latch.

FIG. 6 is a top front perspective in-use view of an embodiment of the disclosure.

FIG. 7 is a front perspective in-use view of an embodiment of the disclosure.

FIG. 8 exhibits a flow chart detailing the process of manufacturing and use of the preferred embodiment of the present invention.

FIG. 9 depicts a view of the present invention as seen from the side profile.

FIG. 10 exhibits a three-dimensional model of the present invention as seen from the top and side.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a disposable sanitary bathroom device configured to function as a multi-function tool which addresses the germ problem caused by lifting a toilet seat, lowering a toilet seat, flushing a toilet, opening/closing a stall door, and activating a faucet with a user's bare hand. The preferred embodiment of the present invention is constructed from sanitary toilet paper and is made for one-time-use only. There is no threat of a user coming in contact with harmful bacteria with proper use of the apparatus of the present invention.

The present invention comprises a four-sided, hand-held, disposable body (10) equipped with a curved end (30), a flat end (20) and parallel indented sides which function as a handle section (50). The present invention may be constructed from molded bathroom tissue or toilet paper pulp. The flat end (20) of the device is configured to engage a user to lift or lower a toilet seat. The curved end is configured to facilitate the user flushing the toilet via a flush lever (80) without touching the toilet. The indented sides of the device, referenced as the handle section (50), is for gripping the device. The device preferably exhibits an hourglass shape. With respect to the device it should be further noted that it is disposable.

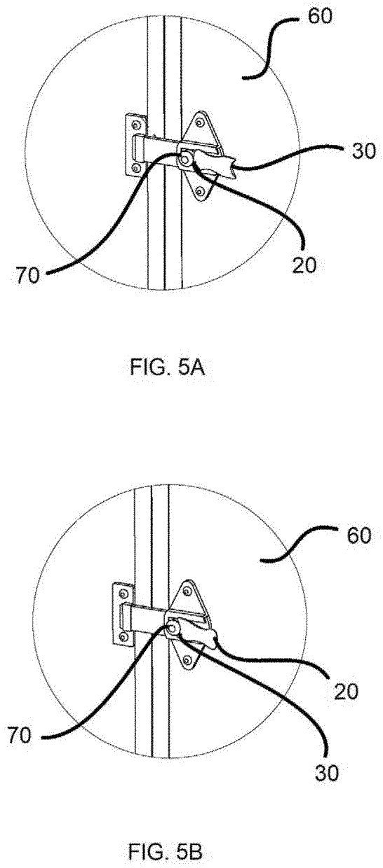

The disposable sanitary bathroom device may be used for other tasks within the bathroom to help minimize the user's contact with bacteria within the bathroom. The device can be used to slide a public bathroom stall door latch (70) to avoid germs as shown in FIG. 5A and FIG. 5B by disposing either the flat end (20) or the curved end (30) against the door latch (70). As such, the present invention allows the user to engage or disengage a public bathroom stall door lock without using their bare hands.

The present invention can also allow a user to engage a push-button toilet flush actuator without using his/her bare hands. The device can also facilitate the user to engage push down faucets to avoid coming in contact with harmful bathroom bacteria. Likewise, the device can also be used to push or pull a bathroom door handle to avoid germs.

The disposable sanitary bathroom device is unique when compared with other known devices and solutions because it provides: (1) minimum contact with bacteria; (2) saves a user from having to touch a toilet seat when lifting or lowering; (3) it saves a user from having to flush a toilet with their bare hands. Similarly, the associated method of use by a user is unique in that it: (1) can engage a push down bathroom faucet; (2) can lock and unlock a bathroom stall door; and (3) can flush a push button toilet. Similarly, the disclosed method of manufacturing and end-of-life is unique when compared with other known processes and solutions in that it: (1) made form toilet paper; (2) is completely hygienic; and (3) can be safely flushed down the toilet without clogging the toilet.

The disclosed device is unique in that it is structurally different from other known devices or solutions. More specifically, the device is unique due to the presence of: (1) ergonomic design; (2) designed from low cost materials; and (3) has multi-functions. Furthermore, the process associated with the aforementioned device is likewise unique. More specifically, the disclosed process owes its novelty to the fact that it: (1) improves restroom hygiene by providing a touch free environment, (2) designed for ease of use, and (3) its structure is designed strictly for disposable use only. In its most complete form, the disposable sanitary bathroom device is completely composed of wet toilet paper or toilet paper pulp, which is then molded into shape and dried. The curved end (30) is preferably molded such that it exhibits two points (40), one on each side. The handle section (50), present in the midsection of the body (10) of the device is molded with indentations on both side for a user to grip the device. A bottom of the device is constructed such that it is preferably flat. Once dried after molding, the device exhibits a solid body (10) that will not bend or break when used properly.

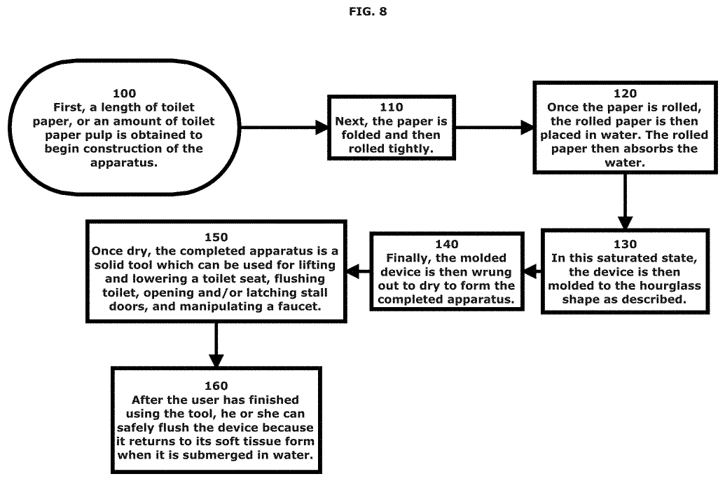

The process of manufacturing and use of the system and apparatus of the present invention, as shown in FIG. 8, is preferably as follows:
1. First, a length of toilet paper, or an amount of toilet paper pulp is obtained to begin construction of the apparatus. (100)
2. Next, the paper is folded and then rolled tightly. (110) Alternately, the pulp is injected into a mold exhibiting the shape of the body (10) of the present invention.
3. Once the paper is rolled, the rolled paper is then placed in water. The rolled paper then absorbs the water. (120)
4. In this saturated state, the device is then molded to the hourglass shape as described. (130)
5. Finally, the molded device is then wrung out to dry to form the completed apparatus. (140)
6. Once dry, the completed apparatus is a solid tool which can be used for lifting and lowering a toilet seat, flushing toilet, opening and/or latching stall doors, and manipulating a faucet. (150)
7. After the user has finished using the tool, he or she can safely flush the device because it returns to its soft tissue form when it is submerged in water. (160)

In some embodiments of the present invention, toilet paper pulp is employed to make the device. In such embodiments, the toilet paper pulp is preferably injected into a manufactured mold exhibiting the shape of the device.

It should be understood that the present invention has multiple functions. The flat end (20) is configured to engage the toilet seat to facilitate a user lifting or lowering the toilet seat without touching the toilet seat with his/her bare hands. This minimizes the user's contact with harmful bacteria. Similarly, the curved end (30) is configured to engage the toilet to facilitate the user flushing the toilet via the flush lever (80) without touching the toilet flush lever (80) (or button) to avoid harmful bathroom germs coming into contact with the user. The handle section (50) of the device is ergonomically designed to help the user to grip the device whether the user is engaging the curved end (30) or the flat end (20) of the device. Both ends of the device can also engage a sliding stall door locking latch (70) in a public bathroom setting as shown in FIG. 5A and FIG. 5B. The body (10) of the present invention is strong enough to lock and unlock a sliding stall door latch without folding, again allowing the user to minimize contact with harmful bacteria conventionally found in bathrooms. The device can also be used to avoid germs on push down bathroom sink faucets and push or pull restroom door handles. Similarly, it should be noted that the present invention may be used to push down a lever-styled bathroom door handle.

It is envisioned that the apparatus of the present invention may be stored in a wall dispenser disposed directly above or adjacent to a toilet or placed on a wall in proximity to the toilet.

With respect to the figures:

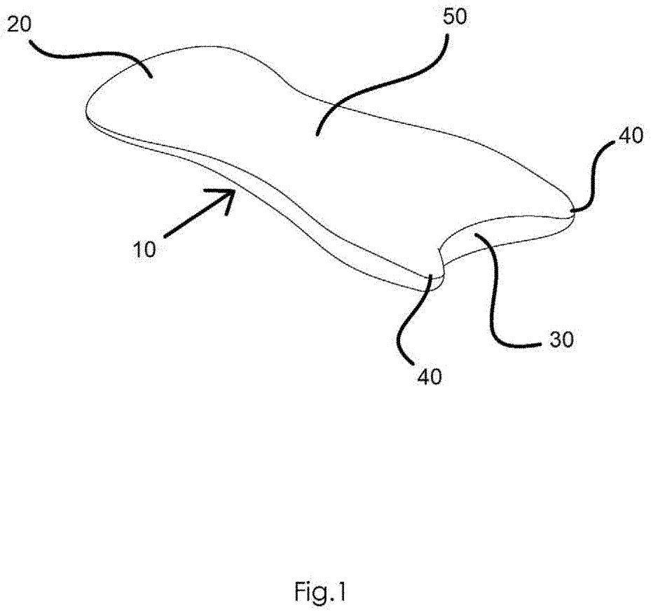

FIG. 1 is a front/side view of the disposable sanitary bathroom device. It is a solid stick comprised of absorbent toilet paper or toilet paper pulp. FIG. 1 shows the flat end of the device at the top and the curved end at the bottom. The center of the device has an indentation for gripping the device.

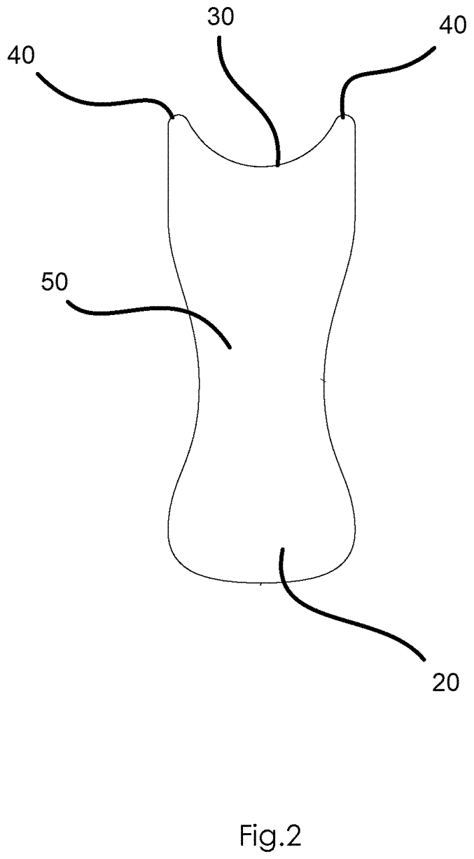

FIG. 2 shows a top-down view of the disposable sanitary bathroom device. The curved end (30), shown at the top, is curved to engage a toilet flush handle and a bathroom stall door lock to facilitate the user flushing the toilet, locking the stall door without touching the handles, or both. The flat end (20) of the device is configured for the user to place between a toilet seat and a toilet bowl to lift the seat without directly touching the seat to avoid germs. The flat end (20) of the device can also aid in a user not touching a push down faucet. The flat (20) end can also help a user push open a bathroom door. The handle section (50), shown as the center portion of the device is designed for the user to maintain a firm grip on the device during use. Once used, the user can safely flush the device away or throw it in the garbage.

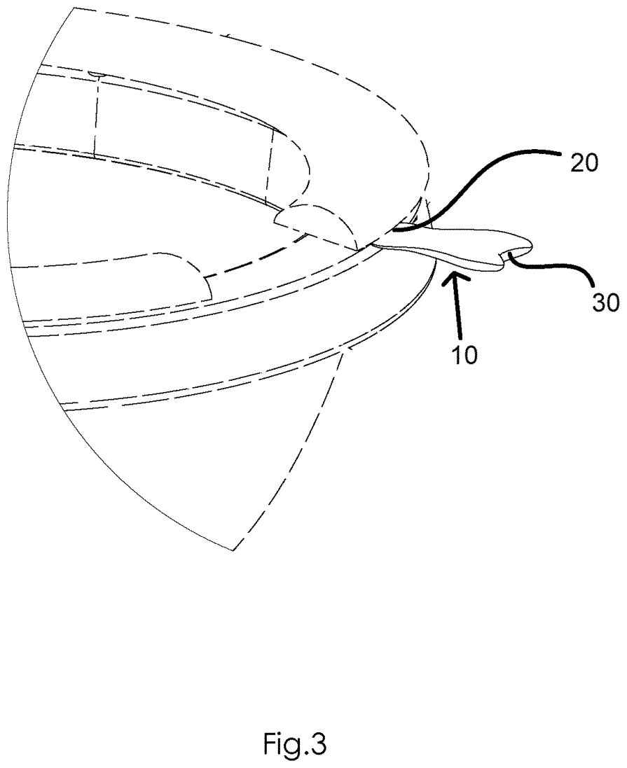

FIG. 3 shows the disposable sanitary bathroom device with the flat end (20) placed in between a toilet bowl and a toilet seat, the user would then lift the toilet seat using the flat end (20) of the device. The user's hand is spaced away from the toilet seat, thereby inhibiting a transfer of bacteria between the toilet and the user's hand. The user could then safely flush away the device.

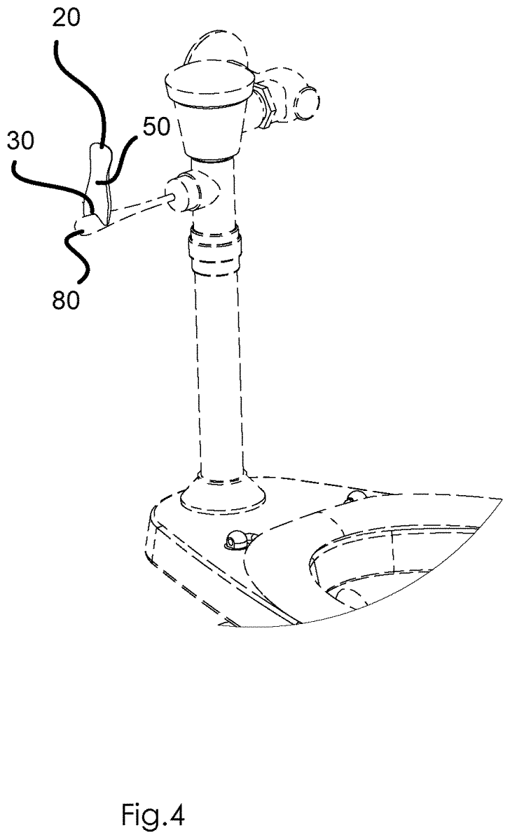

FIG. 4 shows the disposable sanitary bathroom device with the curved end (30) engaging a flush lever (80). The user would push down the flush lever (80) with the curved end (30) of the device to flush the toilet. The device spaces a user's hand away from the flush lever (80), inhibiting the user from coming in contact with harmful germs. The user could then safely flush away the device.

FIG. 5A and FIG. 5B show the disposable sanitary bathroom device engaging a bathroom stall locking latch (70). FIG. 5A shows the flat end (20) of the device engaging a bathroom stall door latch (70). FIG. 5B shows the curved end (30) of the device engaging a bathroom stall door latch (70). Such use of the device inhibits a user from coming in contact with bacteria present on the door latch (70). When the user is finished locking and unlocking the stall door, he or she can safely flush away the device.

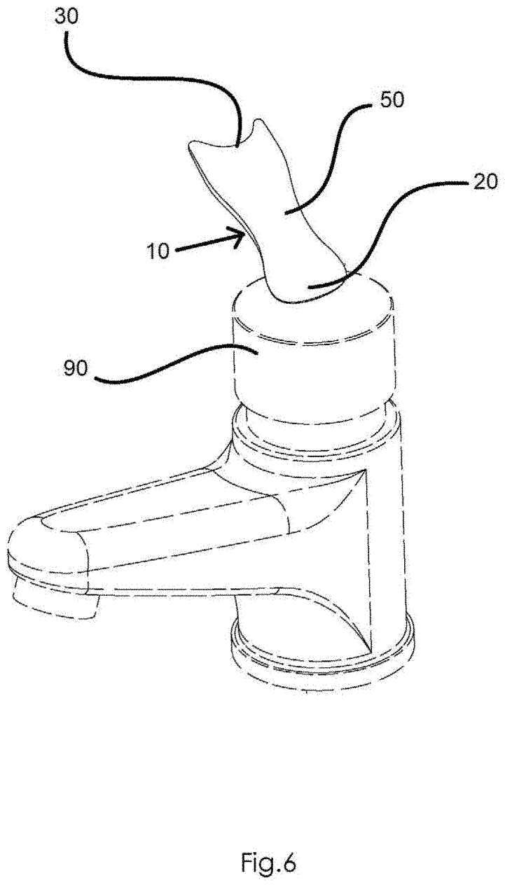

FIG. 6 shows the flat end of the disposable sanitary bathroom device engaging a push down bathroom faucet (90). Using the device on a push-down faucet (90) eliminates a users contact with bacteria. The user could then flush the device of throw it in the garbage.

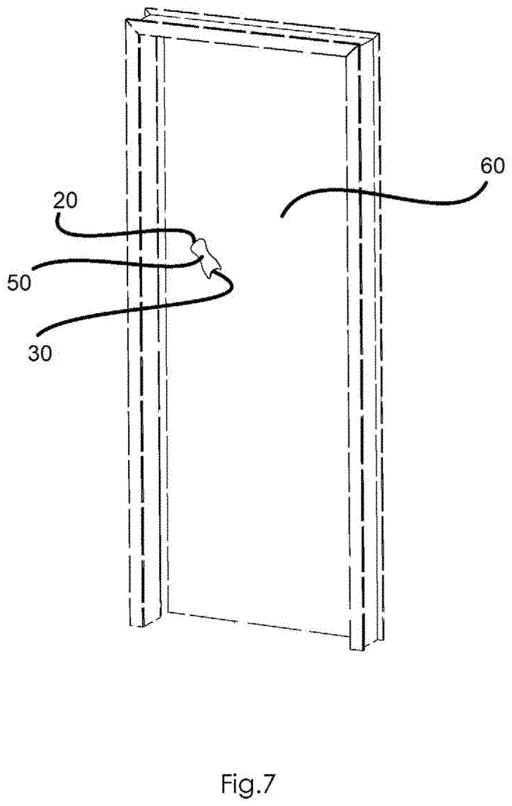

FIG. 7 shows the disposable sanitary bathroom device engaging a bathroom door (60). The user would use the device to aid in pushing open a bathroom door (60), thereby inhibiting a transfer of bacteria between the door and the user's hand. The user could then throw the device in the garbage of safely flush it away.

FIG. 8 outlines a flow chart detailing the general process of manufacturing and use of the present invention as detailed previously in the specification.

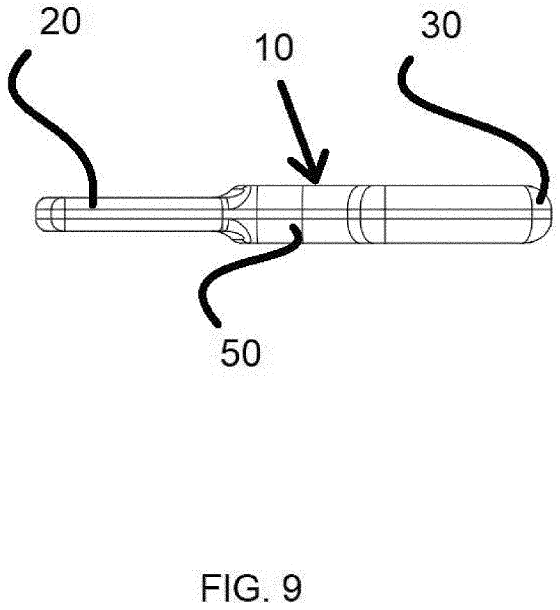

FIG. 9 shows a view of a side profile of the preferred embodiment of the present invention, detailing the contoured shape. It should be noted that the flat end (20) is thinner than the curved end (30).

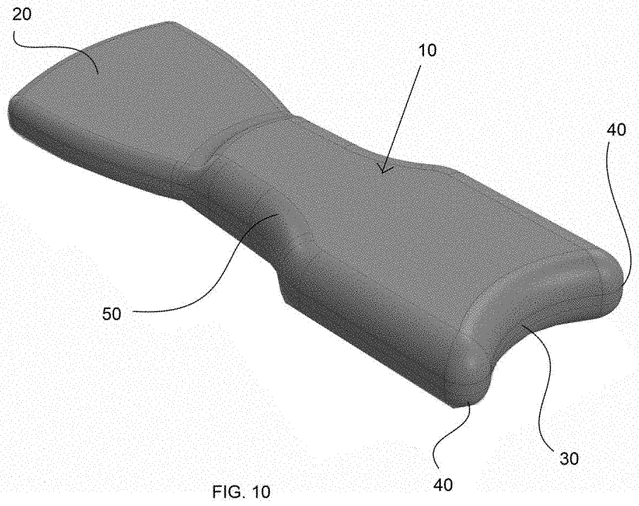

FIG. 10 shows a three-dimensional model of the present invention as seen from the top and side, which shows a sloping region present in the handle section (50) which facilitates a taper down from the curved end (30) toward the flat end (20) of the body (10). It should be noted that the flat end (20) of the body (10) tapers towards a rounded point. Further, it should be understood that the curved end (30) is equipped with a concave curved recess to enable the manipulation of the public bathroom stall door latch (70), as well the flush lever of a toilet.

It should be understood that some alternate embodiments of the present invention may be composed of sugar cane bagasse or similar biodegradable pulp-based materials. In other alternate embodiments of the present invention, the apparatus may be composed of a non-disposable materials such that it may be carried with the user and then washed after each use to facilitate later reuse.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A sanitary apparatus for use by a user to minimize bodily contact with contaminated surfaces of a bathroom comprising:
a body, said body having four sides;
wherein said body is generally planar and oblong;
a flat end, said flat end acting as a first of said four sides of said body;
a curved end, said curved end disposed opposite of said flat end, acting as a second of said four sides of said body;
two indented sides, said two indented sides acting as a third and fourth of said four sides of said body;
wherein said two indented sides are a handle section of said body; and
wherein said body is composed of compressed and dried paper pulp.

2. The apparatus of claim 1, wherein said curved end is equipped with a concave recess configured to enable manipulation of a bathroom stall door latch and a toilet flush lever.

3. The apparatus of claim 1, wherein said flat end tapers towards a rounded point to enable manipulation of a toilet seat and a faucet.
